(19) United States
(12) Patent Application Publication
(10) Pub. No.: US 2006/0191186 A1
(43) Pub. Date: Aug. 31, 2006

(54) Wobbling fishing lure

(76) Inventor: James D. Perrick, Sandy, UT (US)

Correspondence Address: M. REID RUSSELL, 854 WEST 3390 SOUTH, HURRICANE, UT, 84737, US

(21) Appl. No.: 11/404,250

(22) Filed: Apr. 14, 2006

Related U.S. Application Data
(63) Continuation of application No. 10/693,559, filed on Oct. 27, 2003, now abandoned.

(51) Int. Cl. A01K 85/00

(52) U.S. Cl. 43/42.47; 43/42.36; 43/42.25

(57) ABSTRACT

A fishing lure consisting a wingcase wobbler that is arranged for releasable attachment to a bait having, as opposite ends, an eyelet and a barbed hook. The wingcase wobbler is formed from a flat section of a flexible plastic material, may be clear or colored, is shaped with a rounded bow end, and tapers along opposite sides to a flat stern having a slot formed along its longitudinal axis, and with a port formed at a point along the wobbler longitudinal axis that is spaced a greater distance from the stern than the bow. The bait eyelet end fits through the port and the wobbler is bowed to where the slot fits over a stop that is secured to the bait body. The wobbler can be clear or colored, can be notched or serrated along its sides between the port and stern, can include attached items secured along its longitudinal axis, or can be slotted thereacross, and the bait can be wrapped with thread, have feathers attached thereto, or the like, lending an insect appearance to the lure.

### BACKGROUND OF THE INVENTION

This application is a continuation application of application Ser. No. 10/693,559, for a “WOBBLING FISHING LURE” filed Oct. 27, 2003 that is abandoned with the entry of this Continuation application.

### FIELD OF THE INVENTION

This invention pertains to fishing lures, and in particular to fishing lures that provide a very hard wobbling motion to a variety of baits when pulled through the water and will function at much slower retrieval or trolling speeds than other available lures.

### PRIOR ART

The present invention is in a recreational fishing lure that includes a removable “wingcase wobbler”, that provides a hard or more vigorous wobbling motion when pulled through the water and allows for a much slower retrieval or trolling speed that other lures are capable of. With such other lures, at slow speed of travel through the water, the lure tends to descend to the bottom and catch or rocks, limbs, brush, or the like. Further, the invention improves upon presently available lures in that it provides a unique bait detachment arrangement whereby a wingcase wobbler of the invention is readily removable from a bait member, allowing for its use on other bait members.

Earlier lures of the inventor U.S. patents to Perrick, U.S. Pat. Nos. 4,422,260 and 5,857,283, show, respectively, a bait holder and a lure that is a marked improvement over earlier lures for simulating movement of a minnow, or like bait, traveling through water. Such lure, however, does not provide a hard wobbling motion like the wingcase wobbler of the invention. Further, such earlier lure is not appropriate for use at slower retrieval or trolling speeds. Nor could the earlier lure, as set out in the '283 patent, include a wobbler portion or section that is readily removable as is the wingcase wobbler of the invention.

Additional to the earlier '283 patent of the inventor, a number of lures having fish attracting appearances and provide for a vibration or wobble action when pulled through water have been developed and are currently in use. Examples of such trolling lures are shown in U.S. patents to Burns, U.S. Pat. No. 1,910,742; to Accetta U.S. Pat. No. 2,000,734; to Tengel U.S. Pat. No. 2,032,819; to Layfield, U.S. Pat. No. 2,179,641; to Finucan U.S. Pat. No. 2,218,259; to Greggains U.S. Pat. No. 2,298,691; to Wilson U.S. Pat. No. 2,569,792; to Cowden U.S. Pat. No. 2,580,733; to Bunce U.S. Pat. No. 2,805,512; to Czesnocha U.S. Pat. No. 2,817,921; to Warner U.S. Pat. No. 2,851,815; to Crawford U.S. Pat. No. 2,948,984; to Quyle U.S. Pat. No. 3,229,407; to Davis U.S. Pat. No. 3,343,296; to Weis U.S. Pat. No. 3,750,323, to Toivonen U.S. Pat. No. 3,981,096; to Couture U.S. Pat. No. 4,936,041; and to Brackus U.S. Pat. No. 5,446,991, and a Design patent to Reiday, U.S. Pat. No. Des 376,407. None, of which lures, however, provide the removable wiggle plate like the wingcase wobbler and bait of the invention. Similarly, broad cross section of old and modern fishing lures does not show the fishing lure combination of the conveniently removable bowed wiggle plate of the wingcase wobbler or the invention, with examples of such wide variety of fishing including: U.S. patents to Lambrecht U.S. Pat. No. 2,043,001; to Lundemo U.S. Pat. No. 2,463,889; to Freire U.S. Pat. No. 2,619,757; to Carr U.S. Pat. No. 2,787,860; to Dickinson U.S. Pat. No. 3,096,597; to Lievense U.S. Pat. No. 3,495,350; to Norman U.S. Pat. No. 3,541,718; to Perrin U.S. Pat. No. 3,3568,351; to Bauer U.S. Pat. No. 3,673,727; to Werner U.S. Pat. No. 3,753,310; to Austad et al. U.S. Pat. No. 3,848,354; to Smith U.S. Pat. No. 4,122,624; to Wiskirchen U.S. Pat. No. 4,123,870; to Clark U.S. Pat. No. 4,134,324; to Wetherald U.S. Pat. No. 4,201,006; to Johnson U.S. Pat. No. 4,641,455; to Tucker U.S. Pat. No. 4,823,502; and to Phillips U.S. Pat. No. 5,063,704.

Additional to the above, combination hook and like devices for attaching bait, such as small fish, are well known and some examples of such are shown in U.S. patents to Hampton U.S. Pat. No. 1,791,723; to Paspik, U.S. Pat. No. 2,148,074; to Brennan U.S. Pat. No. 2,583,680; and in a Swiss patent to Hass No. 260,496. Like the above cited art, however, none of which devices show the unique configuration of easily detachable wiggle plate and bait that provides, when assembled as a lure and pulled through water, a hard wobbling motion and allows for a slower retrieval or trolling speed as does the wingcase wobbler and bait of the invention

### SUMMARY OF THE INVENTION

It is a principal object of the present invention to provide a sport fishing lure that will have a very hard wobbling motion when pulled through water and can travel at a slow retrieval or trolling speed without contacting the stream or lake bed.

Another object of the present invention is to provide a sport fishing lure that includes a section of clear flexible flat plastic material that is cut or formed to include a lip portion as the wingcase wobbler that is a wobble inducing structure to produce a hard wobbling to an attached bait forming a lure.

Another object of the present invention is to provide a wingcase wobbler for mounting to a bait forward end where the length of the wingcase wobbler, below the mounting point, is a selected percentage greater distance than the distance between the mounting point and the wingcase wobbler bow end.

Another object of the present invention is to provide a wingcase wobbler section that is easily installed onto and removed from a separate bait where the relative size of the wingcase wobbler forward lip to the bait is selected to provide a desired wobbling motion for the selected bait.

Still another object of the present invention is to provide, by a selection of a color of wingcase wobbler, and/or attachments, and the bait configuration, a lure that will have a desired lure appearance for attracting specific fish.

Still another object of the present invention is to provide, by a selection of an outer edge configuration of the wingcase wobbler, a desired lure appearance when viewed from above or below the lure.

Still another object of the present invention is to provide a sport fishing lure that is versatile and easy to use in a large variety of fishing circumstances, allowing the sport fisherman to quickly change the lure appearance for the fishing conditions.

The present invention in a wobbling fishing lure that includes a section of a thin plastic sheet material into a bullet shape having a rounded bow and straight stern between tapered sides as a wobble inducing structure. The wingcase wobbler is formed to be easily mounted onto and detached from a bait that includes a body, eyelet end on a forward portion, and a barbed hook on its opposite end. For mounting, the wingcase wobbler is bowed from an attachment at the bait eyelet end and is attached, in the bowed state, to the bait body. A wobbler forward end is therefore at an angle to the bait forward or eyelet end that is selected to provide, when pulled through water, for wingcase wobbler tipping, from side to side, giving the lure a hard wobbling motion. The wingcase wobbler is mounted onto the bait by fitting the bait eyelet end through a port that has been formed in the wobbler at a location along the wobbler longitudinal axis that is a lesser distance from the bow end than from the stern end. So arranged, from a forward end, the wobbler sides slope outwardly and are equidistant from the wobbler longitudinal axis, terminating in a straight stern end. So arranged, when pulled through water, the wingcase wobbler tips from side to side releasing the pressure of water thereon, giving the lure the hard wobbling motion.

The wingcase wobbler can be formed with a variety of outer edge configurations and in a multitude of colors to provide for attracting fish. To provide for mounting the wingcase wobbler to the bait, to accommodate the bait eyelet end fitted therethrough, the wingcase wobble includes a forward port that is centered laterally and is spaced back from the bow end. A slot is formed in the wobbler stern end that extends a short distance along the longitudinal axis.

The bait is essentially itself a lure in that it has a body with the described eyelet formed on a forward end and includes a barbed hook as its rear or stern end. The body can be wound with tread and have attached feathers, or the like, to give it an insect appearance.

For mounting, the bait eyelet end is fitted through the wingcase wobbler eyelet opening and is bowed to where the stern end slot is passed over a right angle portion of a stop that is formed to extend from the bait body, opposite to the bait barbed hook end. So arranged, the wingcase wobbler is bowed under the bait, with its end above the forward port extending at an angle outwardly and upwardly from the bait eyelet, and is aligned with the bait barbed hook end. With the invention attached to a fishing line at the lure eyelet end, and pulled through water, the; surface of the wingcase wobble, at the bow end, extends upwardly and is forward from the bait, and presents a sloping flat surface that the water contacts, providing resistance to movement, causing the wingcase wobbler to tip from side to side, dumping accumulated water, as it is pulled, to provide a hard wobbling motion to it and the attached bait.

### DESCRIPTION OF THE DRAWINGS

The invention may take physical form in certain parts and arrangements of parts, and a preferred embodiment of which will be described in detail in this specification and illustrated in the accompanying drawings, which form a part hereof:

FIG. 1 is a side elevation taken from a right side identified as Prior Art that shows a fishing lure having a torpedo shaped body wherefrom hooks are suspended and includes a flat wiggle plate mounted to the body forward end that extends at approximately a forty five degree angle forward from the lure longitudinal axis, and includes an eyelet for attaching the lure to a fishing line;

FIG. 2 is a side elevation perspective view of a wobbling fishing lure that includes a wingcase wobbler and bait of the invention that is shown secured, at a bait forward eyelet end, onto a swivel end of a fishing line;

FIG. 3A shows a top plan view of a first embodiment of a wingcase wobbler of the invention;

FIG. 3B shows a second embodiment of a wingcase wobbler of the invention;

FIG. 3C shows a third embodiment of a wingcase wobbler of the invention;

FIG. 3D shows a fourth embodiment of a wingcase wobbler of the invention;

FIG. 4 shows a bottom plan view of a wingcase wobbler of the invention as it would appear when it is bowed and fitted onto a bait and with the wingcase wobbler pulled through water, and shows the wobbler port as a hole that is the pivot point as forward of the wobbler center, providing a greater pivot distance to the wobbler stern than to its bow;

FIG. 5A shows a bait having an eyelet forward end and a barbed hook as its rear end, and showing the bait body as having been wrapped with thread and feathers, and/or the like, lending an insect appearance to the body, with the bait body shown as including a stop that extends out from the body, opposite to the barbed hook, and showing the bait eyelet end fitted through a wing case wobbler port, with arrow B illustrating a force being applied to the wingcase wobbler stern end to bow it towards the stop;

FIG. 5B shows the wingcase wobbler of FIG. 5A as being bowed, illustrated by arrow C, toward the bait body, with a longitudinal slot in the wobbler stern shown aligned, to slide along, the stop;

FIG. 5C shows the wingcase wobbler of FIGS. 5A and 5B as having been bowed, illustrated by arrow D, as having slid alongside the bait stop, with a forward facing leg of that stop having traveled along the wobbler slot and across the slot end, completing the mounting of the wingcase wobbler onto the bait; and

FIG. 6 shows the wingcase wobbler and bait of FIG. 5C as including a second hook having an eyelet end that has been fitted onto the bait barbed hook, providing a double barbed hook bait.

### DETAILED DESCRIPTION

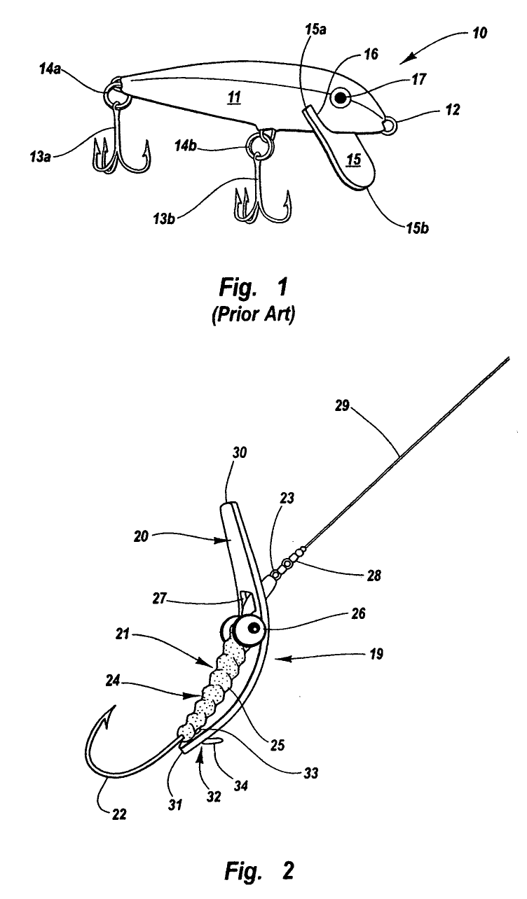

The invention is in a combination of hook bait and a wingcase wobbler for releasable attachment thereto to form a fishing lure that will exhibit a very hard wobbling motion when pulled through water. A number of prior fishing lures have included wiggle plates, with FIG. 1, here identified as Prior Art, showing an example of one such earlier fishing lure 10. The fishing lure 10 includes a torpedo shaped body 11, has en eyelet 12 fitted to its forward or bow end, and includes barbed hooks 13a and 13b mounted to stern and center eyelets 14a and 14b respectively. A wiggle plate 15 is shown with its rear end 15a fitted into a straight slopping slot 16 that has been formed into the body 11, below an eye 17, with the wiggle plate 15 extending at an angle of between thirty and sixty degrees from the body 11 longitudinal axis. So arranged, with the lure 10, pulled through the water, the wiggle plate provides drag and collects and then tilts to dump water. This action provides an oscillating or wobbling motion to the fishing lure. 10. Such wobbling motion, however, is limited by the placement of the wiggle plate 15 junction with the bait, ahead of the fishing lure 10 center of gravity, and by the stiff nature of the plate. Distinct therefrom, the wingcase wobbler of the invention is positioned to be essentially centered at the line swivel, and extends from the top rather than out from the lure bottom. So arranged, an enhanced, very hard wobbling motion, away from the bottom, is provided by the invention as it is pulled through water.

FIG. 2 shows a wingcase wobbler 20 of the invention that has been bowed and attached onto a bait 21, forming a lure 19. The wingcase wobbler 20 is mounted on top of bait 21, with a hook end 22 of the bait aligned with the wingcase wobbler 20. So arranged, with the removable wingcase wobbler 20 fitted over the bait 21, a bait forward eyelet 23 end is fitted through a port 27 that is formed through the wingcase wobbler 20, acting as a pivot point of the wingcase wobbler to a fishing line whereto the wobbler is secured. The section of the wingcase wobbler 20 above or forward of the line pivot coupling is contacted by the force of water as the lure 19 is pulled through water. The water contacting the surface of the wingcase wobbler 20, above the pivot point, loads the wobbler surface, causing the wingcase wobbler to pivot from one side to the other, dumping accumulated water. The lure thereby swings back and forth through across the line, providing a very hard wobbling motion. Which wobbling motion also tends to maintain the lure off the bottom even at considerably slower retrieval or trolling speeds than has heretofore been possible with earlier lures, like the lure 10 of FIG. 1. In practice, the wingcase wobbler 20 creates a more active lure movement than has a lure with a bottom mount plate like that of the lure 10 of FIG. 1.

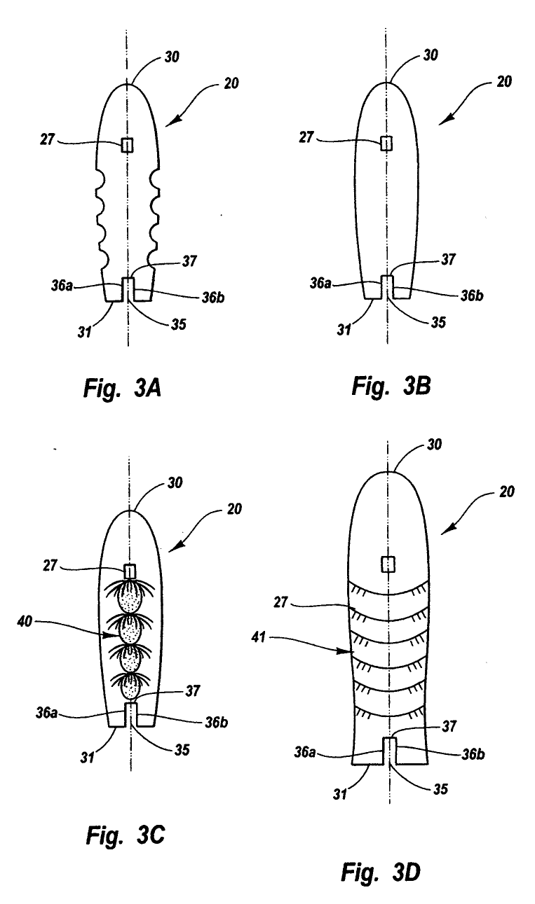

In FIG. 2 the lure 19 is shown as including the bait 21 having a barbed hook 21 end formed as the stern end, a center body section 24 that has been wrapped with thread 25 and includes a pair eyes 26 attached to sides of the bait end, and to a bait eyelet 23 end. The eyelet end 23, as shown, is passed through port 27 that is formed through the wingcase wobbler 20 and is then attached to a swivel end 28 of a fishing line 29. The wingcase wobbler 20 port 27 is formed along the wobbler longitudinal axis, forward of the center, and the distance between the wobbler port 27 to the rear or stern end 31 is dependent upon the size of the bait and lip as are used, with, in practice, the distance is approximately one hundred (100) to one hundred seventy five (175) percent greater than the spacing distance from the port 27 to the wobbler front end or bow 30. Further, the spacing distance from the port 27 to an end 37 of a slot 35 formed into the stern end 31, as shown in FIGS. 3A through 3D, is at least one hundred (100) percent or greater, or is at least twice, the distance from the port 27 to the bow end 30.

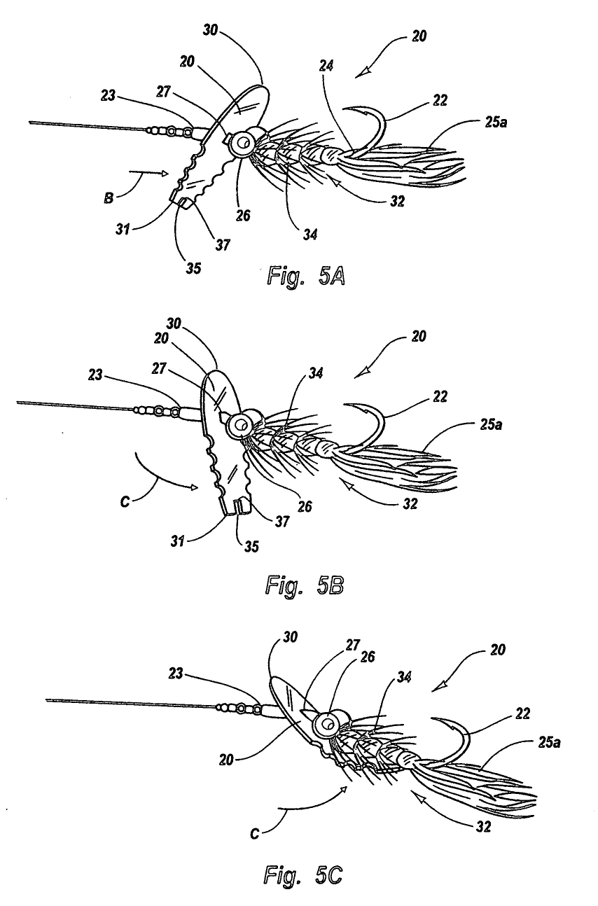

For maintaining the wingcase wobbler 20 in a bowed state, as shown in FIG. 2, the bait body 24 includes a stop 32 that is preferably formed from metal as an angle section. The stop 32 has a base leg 33 that is either secured on its end to the hook 22 body 24, or includes an right angle section to that base leg 33 end, not shown, is held in place by thread, or the like, that is wound around the bait in forming the bait body. The stop 32 base leg 33 connects to a straight portion 34 that faces towards the hook 22 eyelet end. The stop 32 is to receive and pass along a slot 35 that, as shown best in FIGS. 3A through 3D, is formed longitudinally into the wingcase wobbler stern end 31, a short distance along the center longitudinal axis. Thereby, with the wobbler bowed, as shown in FIGS. 5A through 5C, the slot 35 is passed along the stop 32 base leg 33 to where that stop base leg 33 contacts the slot 35 end 37. The bowing force applied to the wingcase wobbler 20 is then released after the slot 35 sides have traveled along opposite sides of the stop 32 base leg 33 and the slot end 37 has engaged the stop 32 base leg 33. The wingcase wobbler is maintained in a bowed state, holding the wingcase wobbler 20 on the bait 21, as shown in FIG. 2. So arranged, the wingcase wobbler 20 will remain securely mounted onto the bait 21, when pulled through water, with the force acting on the wobbler during trolling tending to urge the slot end 37 against the stop 32 base leg 33, locking the wobbler in place onto the bait.

As set out above, the bait 21 can include thread wound around the hook 24, and may also include feathers, or the like, that the thread is wound around, that can also provide for connecting the stop 32 onto the hook body. Which thread winding can also provide for attaching other decorations as are deemed appropriate to attract fish to the lure 19. Similarly, to provide for attracting fish to the lure 19, the wingcase wobbler, as shown in FIGS. 3A through 3D can be shaped as by, but not limited to: having its edges below the port 27 notched or serrated, as shown in FIG. 3A; can be formed to have a torpedo shape from its bow 30 to flat stern 31, as shown in FIG. 3B; can include attached items connected to the wobbler, as by gluing or are formed into the wobbler, forming a pattern 40 into or on the wobbler, as shown in FIG. 3C; or can include a pattern of spaced saw tooth ridges 41, as shown in FIG. 3D, formed therein; or the wobbler can include, or be formed with, other patterns or shapes, within the scope of this disclosure. All of such arrangements are formed between the port 27 and stern 31, thereby maintaining the forward portion above the port 27 in a bullet shape, and with the wobbler edge portions equidistant from the wobbler center longitudinal axis. So arranged, identical wobble periods or travel or motion on each side of the lure are provided as it is pulled through the water. Additionally, the wingcase wobbler 20 can be colored over all or part of its surface, can be spotted, or the like, as is appropriate for attracting fish.

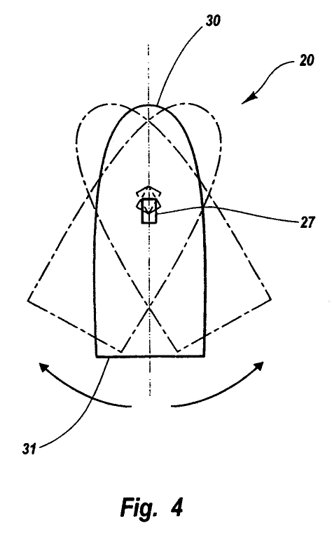

Shown in FIGS. 3A through 3D and 4, the wingcase wobbler 20 port 27 is spaced from the wobbler center, along its longitudinal axis to between the bow and stern ends 30 and 32, respectively. The port 27 receives the hook eyelet fitted therethrough and is for mounting the lure 19 to a fishing line swivel end and its therefore the lure pivot point. So arranged, the portion of the wobbler from the port 27 to the stern 31 is preferably at greater distance than from the wobbler bow 31, producing a greater distance of back and forth travel across the swivel than that experienced at the wobbler bow end 31. This stern end travel is transmitted into the bait and provides a very strong or heavy wobble to that bait as the lure is pulled through the water. The distance from the port 27 to the stern end 31 is dependent upon the size of the bait and lip as are used, with, in practice, the distance is approximately one hundred (100) to one hundred seventy five (175) percent greater than the spacing from the port 27 to the bow end 30. Further, the spacing distance from the port 27 to an end 37 of a slot 35 formed into the stern end 31, as shown in FIGS. 3A through 3D, is at least one hundred (100) percent or greater, or at least twice the distance from the port 27 to the bow end 30. Additionally, with the wobbler bow end 30 extending upwardly from the bait 21, the lure 19 tends to stay off the bottom, even at slow towing speeds.

FIG. 5A through 5C show an embodiment of the wingcase wobbler 20 being fitted onto a bait 21. The bait 21 is shown as a hook having a wire body 24 that has been fitted with feathers 25a and the body and feathers are wrapped with thread 25. The bait 21 includes a barbed hook 22 as its stern end, and has an eyelet 23 on its bow end, and with eyes 26 fitted to opposite sides of the bait forward portion. The eyelet 23 is shown as having been fitted through the wingcase wobbler 20 port 27. So arranged, to assemble the lure 19, an operator, not shown, holds the wobbler bow end 30 and pivots the wobbler lower portion towards the bait stop 32, as illustrated by arrow B. They then urge the wingcase wobbler stern end 31 slot 35 towards the stop 32. FIG. 5B is a view like that of FIG. 5A, only showing, with arrow C, the wobbler stern end 35 as having been moved towards the bait stop 32 base leg 33 and passed under the straight portion 34 to where the stop straight portion fits over the slot 35 end 37, as shown in FIG. 2. The wobbler is thereby maintained in a bowed state between the port 27 and bait eyelet end 23 and at stop 34. So arranged, when the lure 20 is pulled through water the wobbler, the area of the wobbler from the port 27 to the bow 30 experiences a water buildup that causes it to tip from one side to the other, dumping the load created by that water buildup, creating a wobbling action in the connected bait 21. This wobbling motion, along with the bait appearance and coloring of the wingcase wobbler and/or bait, and/or the items secured onto the wobbler, and/or the configurations of the wobbler edges, present a fish attracting lure.

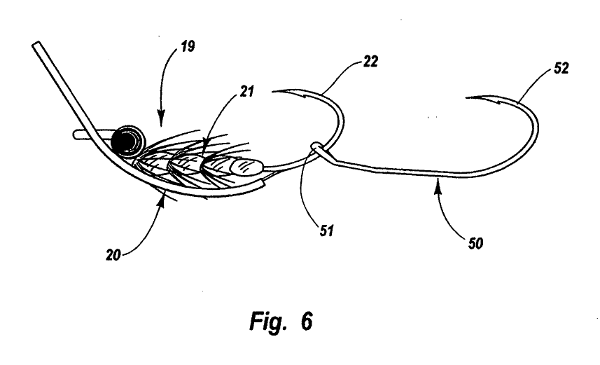

FIG. 6 shows a lure 19 that includes a wingcase wobbler 20 and bait 21, with the bait shown as including a barbed hook end 22 that has had an eyelet 51 end of a second bare hook 50 slid over the bait hook 22 barbed. In which configuration, the bait hook barbed end 22 resists reverse passage of the eyelet 51 thereover. The second hook 50 also preferably has a barbed end 52 and provides a second fish hooking arrangement.

Summarizing, the invention is in the wingcase wobbler 20 and its bowed mounting to a bait that includes at least a single hook, that may be a bait that has been dressed as with thread, feathers, and the like, or is otherwise configured to attract fish. The wingcase wobbler can itself have items attached thereto such a thread, beads, or the like, can be colored. It can also include grooves, raised areas, or the like, formed thereacross, below the port whereto the hook eyelet end is fitted. Additionally, it can include notches formed along opposite edges, below the port to the stern, or the like. Which inclusions provide a lure that is attractive to the particular type and variety of fish that a person is fishing for, at a particular time of day.

Herein is shown embodiments of my invention in a wingcase wobbler and its mounting, in a bowed state, onto a bait that includes a hook. It will, however, be apparent to one knowledgeable or skilled in the art that the above described embodiments may incorporate changes and modifications without departing from the general scope and subject matter of the invention. Which invention. it should be understood, is intended to include all such modifications and alterations in so far as they come within the scope of the appended claims and/or a reasonable equivalence thereof.

I claim:

1. A wobbling fishing lure comprising, a wingcase wobbler that is formed from a section of a flat flexible material, has a round bow end with spaced sides tapering outwardly therefrom that end in a stern and includes a port formed along the wingcase wobbler longitudinal axis that is spaced a greater distance from the stern than from the bow ends of said wingcase wobbler, and said stern is arranged for coupling to a bait along said longitudinal axis; and a bait that includes a body having a barbed hook on a rear end and an eyelet formed in its forward end and includes a stop means to receive and hold said wingcase wobbler stop means that is formed as a right angle section where said stop base end is secured to said bait body, extending oppositely to said hook, and includes a leg extending at approximately a right angle from the stop base towards said bait eyelet end.

2. The wobbling fishing lure as recited in claim 1, wherein the wingcase wobbler is formed from a section of a flexible plastic material; and the distance of the port from the stern end is approximately one hundred to one hundred seventy five percent greater than the distance from said port to the bow end.

3. The wobbling fishing lure as recited in claim 1, wherein the bait stop is formed as a right angle section where said stop base end is secured to said bait body, extending therefrom oppositely to the hook, and includes a leg that extends at approximately a right angle from the stop base toward the bait eyelet end and is to fit into a slot formed in said wingcase wobbler stern extending a short distance along its longitudinal axis wherealong said stop leg travels over said slot end

4. The wobbling fishing lure as recited in claim 1 further including the wingcase wobbler is colored.

5. The wobbling fishing lure as recited in claim 1, further including the wingcase wobbler sides are identically notched at spaced intervals along the opposite sides thereof, between the port and the stern end.

6. The wobbling fishing lure as recited in claim 1, further including the wingcase wobbler has decorative items secured along the longitudinal axis, between the port and stern end.

7. The wobbling fishing lure as recited in claim 1, further including lateral slots or raised areas formed at spaced intervals across the wingcase wobbler, between the port and stern ends.

8. The wobbling fishing lure as recited in claim 1, wherein the bait is a hook having a center body, an eyelet on one end and a barbed hook on the other end with the stop secured to said body, below and pointing oppositely to said hook; and said body is wrapped with thread to lend an insect appearance thereto.

9. The wobbling fishing lure as recited in claim 8, wherein feathers are wrapped onto the body; and eyes are fitted to opposite sides of said body, adjacent to the eyelet.

10. The wobbling fishing lure as recited in claim 8, further including a second hook having an eyelet end that is fitted over said bait hook barbed hook.
